(19) United States
(12) Patent Application Publication
(10) Pub. No.: US 2026/0162230 A1
(43) Pub. Date: Jun. 11, 2026

(54) IMAGE NOISE CANCELLATION FOR OPTICAL INSPECTION OF SEMICONDUCTOR STRUCTURES

(71) Applicant: Taiwan Semiconductor Manufacturing Company, Ltd., Hsinchu (TW)

(72) Inventors: Chien-Huei CHEN, Hsinchu (TW); Xiaomeng CHEN, Hsinchu (TW); Han-Ru CHEN, Hsinchu (TW); Chien-Yu LIN, Hsinchu (TW)

(73) Assignee: Taiwan Semiconductor Manufacturing Company, Ltd., Hsinchu (TW)

(21) Appl. No.: 19/182,277

(22) Filed: Apr. 17, 2025

Related U.S. Application Data
(60) Provisional application No. 63/730,659, filed on Dec. 11, 2024.

(51) Int. Cl. G06T 5/70; G06T 5/50; G06T 5/60

(52) U.S. Cl. CPC G06T 5/70; G06T 5/50; G06T 5/60; G06T 2207/20081; G06T 2207/20084; G06T 2207/20224; G06T 2207/30148

(57) ABSTRACT

An method embodiment includes generating a first image of a prior layer in a semiconductor structure, generating a second image of an inspection layer in the semiconductor structure, transforming the first image using a deep learning model to generate a noise-cancellation image, and removing image noise from the second image based on the noise-cancellation image.

### CROSS-REFERENCE TO RELATED APPLICATION

This application claims priority to U.S. Provisional Patent Application No. 63/730,659, filed on Dec. 11, 2024, the entire disclosure of which is incorporated herein by reference.

### BACKGROUND

Integrated circuit (IC) design becomes more challenging as IC technologies continually progress towards smaller feature sizes, such as 32 nm, 28 nm, 20 nm, and below. For example, when fabricating IC devices, IC device performance is influenced by lithography printability capability, which indicates how well a final wafer pattern formed on a wafer corresponds with a target pattern defined by an IC design layout. As the patterns become increasingly intricate, the need for high-resolution inspection systems to accurately detect and address defects becomes more pronounced.

### BRIEF DESCRIPTION OF THE DRAWINGS

The present disclosure is best understood from the following detailed description when read with the accompanying figures. It is emphasized that, per the standard practice in the industry, various features are not drawn to scale and are used for illustration purposes only. The dimensions of the various features may be arbitrarily increased or reduced for clarity of discussion.

FIG. 1 is a block diagram of a method of image noise reduction, according various embodiments.

FIG. 2A is a top view of a prior layer in a semiconductor device structure, according to various embodiments.

FIG. 2B is a top view of a prior layer in a semiconductor device structure, according to various embodiments.

FIG. 2C is a top view of an inspection layer of a semiconductor device structure, according to various embodiments.

FIG. 3 is a vertical cross-sectional view of the semiconductor device structure of FIGS. 2A to 2C, according to various embodiments.

FIG. 4A is a block diagram of details of a method of generating first images of prior layers, according to various embodiments.

FIG. 4B is a block diagram of a first deep learning model, according to various embodiments.

FIG. 4C is a block diagram of a method of training the first deep learning model, according to various embodiments.

FIG. 5A is a block diagram of a method of training a second deep learning model, according to various embodiments.

FIG. 5B is a block diagram of a method of applying the second deep learning model for defect detection, according to various embodiments.

FIG. 5C is a three-dimensional perspective view of an inspection tool that includes a plurality of custom chips representing respective prior layers, according to various embodiments.

FIG. 5D is a block diagram of details of a method of generating first images of prior layers and training a deep learning model, according to various embodiments.

FIG. 6 is a flowchart of a method of removing image noise from an image of an inspection layer in a semiconductor structure, according to various embodiments.

FIG. 7 is a flowchart of a method of removing image noise from an image of an inspection layer in a semiconductor structure, according to various embodiments.

FIG. 8 is a flowchart of a method of detecting defects in a semiconductor structure, according to various embodiments.

FIG. 9 is a schematic layout of a computer system configured to perform the methods of FIGS. 6, 7, and 8, according to various embodiments.

### DETAILED DESCRIPTION

It is to be understood that the following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values but may depend upon process conditions and/or desired properties of the device. Moreover, the formation of a first feature over or on a second feature in the description that follows include embodiments in which the first and second features are formed in direct contact, and may also include embodiments in which additional features may be formed by interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “being made of” may mean either “comprising” or “consisting of.” In the present disclosure, the phrase “one of A, B and C” means “A, B and/or C” (A, B, C, A and B, A and C, B and C, or A, B and C), and does not mean one element from A, one element from B and one element from C, unless otherwise described.

One or more of the disclosed embodiments advantageously disclose methods of inspecting an inspection layer (IL) in a semiconductor device layer based on information collected from one or more previously formed layers (also referred to as prior layers (PL)). In this regard, disclosed systems and methods transform images from one or more prior layers, together with layout and process critical dimensions (CD), to generate one or more noise cancellation images that are effective in suppressing the noise in the inspection layer image. The generation of these noise cancellation images uses deep learning capabilities of vision transformer models which leverage layout information and are conditioned with CD data of the inspected wafer.

Optical inspection is a useful tool for detecting yield-impact defects in semiconductor wafers and devices due to its speed and versatility. However, in advanced node structures, yield-impact defects not only become smaller but also tend to be embedded within nanoscale structures. For many types of embedded defects, optical waves can penetrate the nanoscale structure and capture signals from these defects. However, since most of these defects are on the nanoscale, the defect signals are very weak. During the detection process, these weak signals are often obscured by noise caused by structures or material variations in prior layers, making the defect signals difficult to detect.

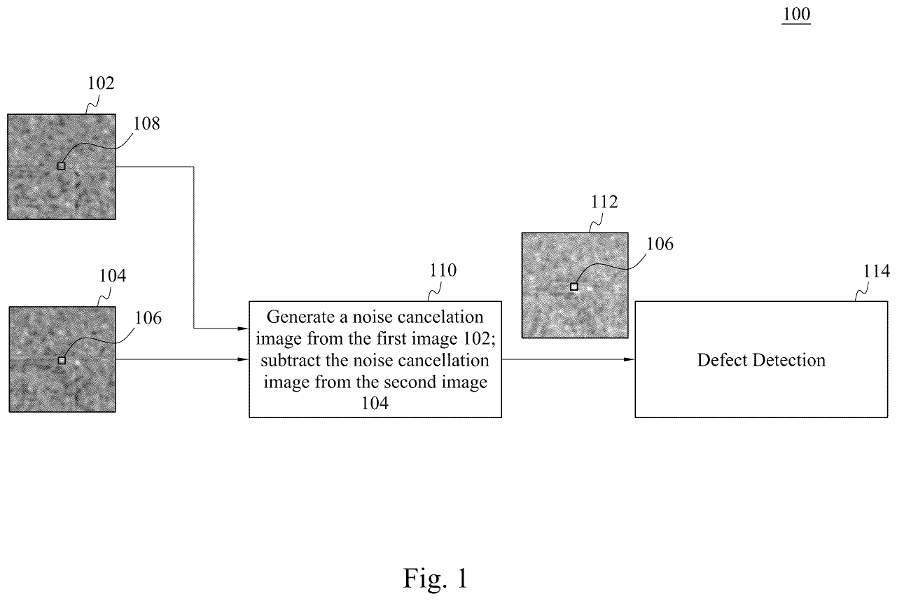

FIG. 1 is a block diagram of a method 100 of image noise reduction, according to various embodiments. According to the method 100, a first operation includes generating a first image 102 of a prior layer in a semiconductor structure during or after the formation of the prior layer and generating a second image 104 of an inspection layer during or after the formation of the inspection layer. The second image 104 shows the presence of a defect 106 in the inspection layer and a region-of-interest 108 is illustrated in the first image 102. The region-of-interest 108 does not correspond to a defect in the prior layer but is used to highlight a region that generates a noise signal that tends to obscure a defect signal that is generated by the defect 106 in the inspection layer.

The method 100 further includes using a deep learning model to transform the first image 102 to generate a noise cancellation image as indicated in block 110. The noise cancellation image is then subtracted from the second image 104 to generate a corrected image 112 of the inspection layer, as further indicated in block 110. The method 100 further includes performing a defect detection algorithm on the corrected image 112, as indicated in block 114. According to some embodiments, the method 100 selects at least one prior layer that contributes image noise to the inspection layer. This determination uses process knowledge; for example, when inspecting poly layers, global etching variations are often a significant source of noise.

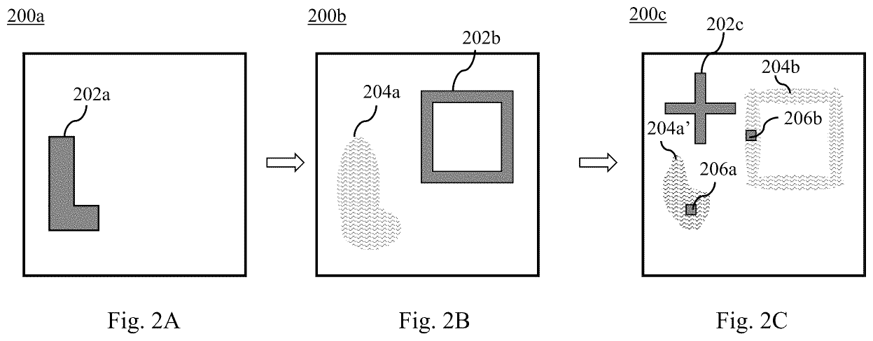

FIGS. 2A and 2B are top views of prior layers (200a, 200b) and FIG. 2C is a top view of an inspection layer 200c of a semiconductor device, according to various embodiments. The first prior layer 200a has a first layout including a first geometric pattern 202a, the second prior layer 200b has a second layout including a second geometric pattern 202b, and the inspection layer 200c has a third layout including a third geometric pattern 202c. As such, the semiconductor device is a stacked structure in which the second prior layer 200b is formed over the first prior layer 200a, and the inspection layer 200c is formed over the second prior layer 200b. Inspection layer 200c also includes two nano-scale defects 206a, 206b. In other embodiments, inspection layer 200c has a greater or lesser number of defects.

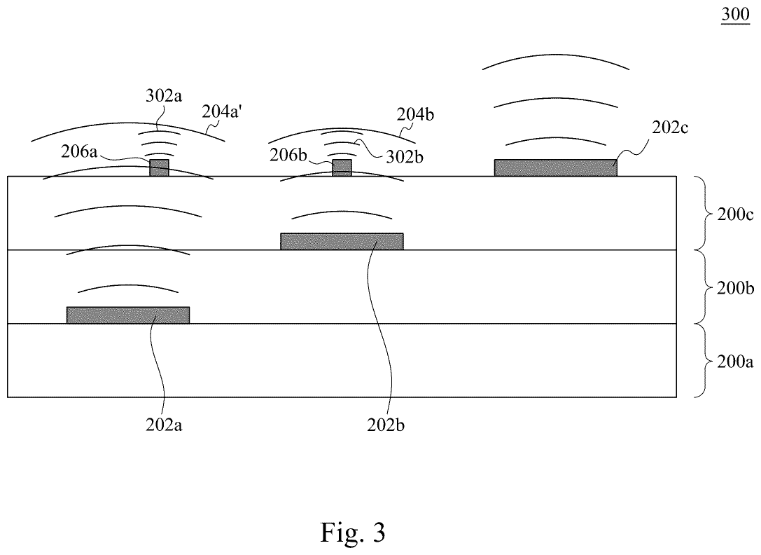

Inspection radiation (e.g., light or an electron beam) that is introduced to inspect the inspection layer 200c propagates within the structure and scatters from the various geometric patterns (202a, 202b, 202c). As such, first radiation 204a that is scattered from the first geometric pattern 202a propagates in various directions including upward through the second prior layer 200b and a top surface of the inspection layer 200c. The presence of the first radiation 204a therefore generates a noise signal 204a′ that tends to obscure a first defect signal 302a scattered from the first nano-scale defect 206a (e.g., see FIG. 3). Similarly, second radiation 204b that is scattered from the second geometric pattern 202b propagates in various directions including upward through the top surface of the inspection layer 200c. The presence of the second radiation 204b therefore acts as a noise signal that obscures a second defect signal 302b scattered from the second nano-scale defect 206b (e.g., see FIG. 3).

FIG. 3 is a vertical cross-sectional view of the semiconductor device structure 300 of FIGS. 2A to 2C, according to various embodiments. As shown, the semiconductor device structure 300 includes a second prior layer 200b formed over a first prior layer 200a and an inspection layer 200c formed over the second prior layer 200b. As described above, the semiconductor device structure 300 includes a first geometric pattern 202a formed on a surface of the first prior layer 200a, a second geometric pattern 202b formed on a surface of the second prior layer 200b, and a third geometric pattern 202c formed on a surface of the inspection layer 200c.

The first radiation 204a originates as a first portion of inspection radiation (e.g., light or an electron beam) that is scattered from the first geometric pattern 202a and the second radiation 204b originates as a second portion of the inspection radiation that is scattered from the second geometric pattern 202b. The first radiation 202a in the second prior layer 200b propagates to the inspection layer 200c and thereby gives rise to first radiation 202a′ in the inspection layer 200c. The first radiation 204a′ and the second radiation 204b tend to drown out (i.e., obscure) the first defect signal 302a and the second defect signal 302b, respectively. As such, the first radiation 204a′ and the second radiation second radiation 204b act as unwanted noise sources. As illustrated in FIGS. 2A to 3, the spatial distribution and intensity of the noise sources (204a′, 204b) change as the radiation propagates through the structure (200a, 200b, 200c) due to reflection and refraction. As such, the first image 102 (e.g., see FIG. 1) captured during or after the formation of the prior layers (200a, 200b) cannot be used to remove the noise sources (204a′, 204b) at the inspection layer 200c by subtracting such first images 102 from a second image 104 of the inspection layer, because the second noise sources (204a′, 204b) are not simple replicas of their sources in the underlying layers.

Based on the above insights, one or more embodiments use deep learning models to automatically transform image data from one or more prior layers to generate at least one noise-cancellation image that approximates the noise sources (204a′, 204b) found in a second image 104 of an inspection layer 200c. Such a noise-cancellation image is then subtracted from the second image 104 to remove the unwanted noise sources (204a′, 204b) from the second image 104, thus improving a signal-to-noise ratio of the defect signals (302a, 302b). As such, detection of nano-scale defects is significantly improved.

One or more embodiments leverage image data from multiple prior layers for complete coverage of prior-layer noise sources and utilize layout information to distinguish regions within each prior layer image 102 for more effective noise cancellation in comparison with other approaches. The disclosed deep-learning models are trained to determine an optimal selection of prior layers based on layout and weighting. Various embodiments further incorporate the inspection layer's CD and film stack data to adjust the weighting of prior layer images in the image-noise canceling operation. Images for both the inspection layer and prior layers are aligned to a design layout as a common reference. This use of a common reference achieves optimal alignment thus reducing errors that would otherwise be generated due to misalignment between images that are subsequently subtracted. According to various embodiments, the data used to train the deep learning model is collected based on experimental measurements of fabricated semiconductor structures. Alternatively, in other embodiments, data used to train the deep learning model is generated based on numerical simulations based on the theory of physical optics.

Deep learning models are advanced machine learning algorithms designed to automatically learn patterns and features from large amounts of data. These models are based on artificial neural networks that consist of multiple layers of interconnected nodes, or “neurons,” that process and hierarchically transform input data. The specific types of deep learning models that can be used for semiconductor applications include, but are not limited to, convolutional neural networks (CNNs), vision transformers, recurrent neural networks (RNNs), and fully connected deep neural networks (DNNs).

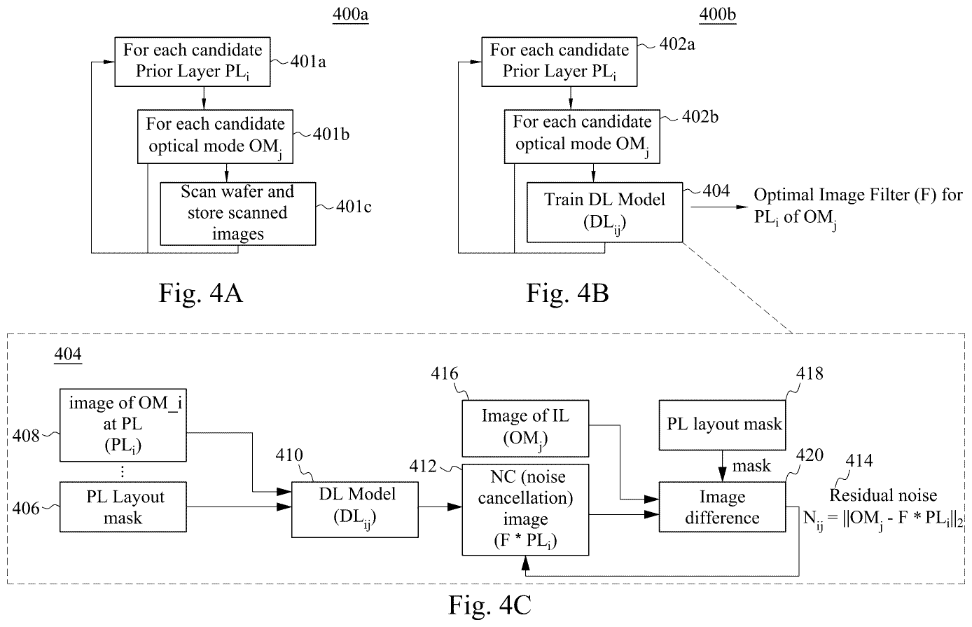

In block 404, and described in greater detail with reference to FIG. 4C, the first deep-learning model is trained to identify various features (e.g., using self-attention mechanisms) including image noise sources in each first image 102. In a vision transformer, for example, the self-attention mechanism helps distinguish between noise and actual image content by calculating attention scores that reflect the relationships between image patches. Noise, which is characterized by random variations in pixel values, appears as high-frequency patterns, local disturbances, and/or irrelevant correlations that do not follow the natural structure of the image. Because noise does not align with the spatial structure of the image, the self-attention mechanism assigns low importance to noisy patches. The mechanism recognizes these patches as less relevant because they disrupt the meaningful correlations seen between neighboring image patches.

The self-attention mechanism in a vision transformer works by focusing on patches that exhibit coherent spatial relationships, such as edges or textures, while ignoring patches that contain random, uncorrelated noise. Through this process, the model suppresses the influence of noise, enabling the model to concentrate on the more structured content of the image. The attention mechanism highlights patterns of coherence that represent actual content, such as gradual transitions in color and intensity, which indicate true image features. In contrast, noise does not maintain any consistent relationship with its surroundings, and this lack of structure enables the model to reduce or disregard noisy patches.

Similarly, in a convolutional neural network (CNN), noise identification and reduction are primarily driven by the network's ability to learn spatial hierarchies through the convolutional layers. A CNN processes an image by applying filters (kernels) that slide over the image to detect local patterns and features, such as edges, textures, and/or shapes. Noise manifests as random, high-frequency fluctuations that do not correspond to any meaningful image structure. Because CNNs focus on learning spatial relationships, the convolutional filters are trained to recognize these inconsistencies, which appear as irregular patterns that disrupt the natural flow of image features.

During training, a CNN learns to differentiate between the relevant content of the image and noise by adjusting its filters to capture and enhance important features while minimizing the impact of noise. The network's first layers often detect low-level features like edges, corners, or simple textures, which are usually unaffected by noise. As the image progresses through deeper layers, the CNN combines these low-level features into more complex structures, like objects or regions of interest. Noise, being random and uncorrelated, does not form coherent patterns at these higher levels. Therefore, CNNs tend to learn to focus on the stable, structured patterns of the image while ignoring the erratic disturbances caused by noise.

The convolutional filters in the network automatically learn to recognize noise through their receptive fields, which are regions of the image they focus on. Filters that are sensitive to high-frequency components are more likely to detect noise, as noise tends to introduce high-frequency variations that are not part of the image's true structure. CNNs suppress these noise components by applying more focused, lower-frequency filters in the deeper layers, which naturally smooth out the image and enhance its meaningful features. Additionally, pooling layers, which reduce the spatial resolution of the image, further help in noise reduction by averaging out the variations in pixel values across larger regions, thereby smoothing out random disturbances. Thus, convolutional neural networks identify noise by learning to differentiate between high-frequency, random fluctuations and the more consistent, meaningful patterns within an image. Through their hierarchical structure, CNNs focus on relevant features while suppressing the irrelevant, noisy components, effectively reducing noise, and enhancing image quality.

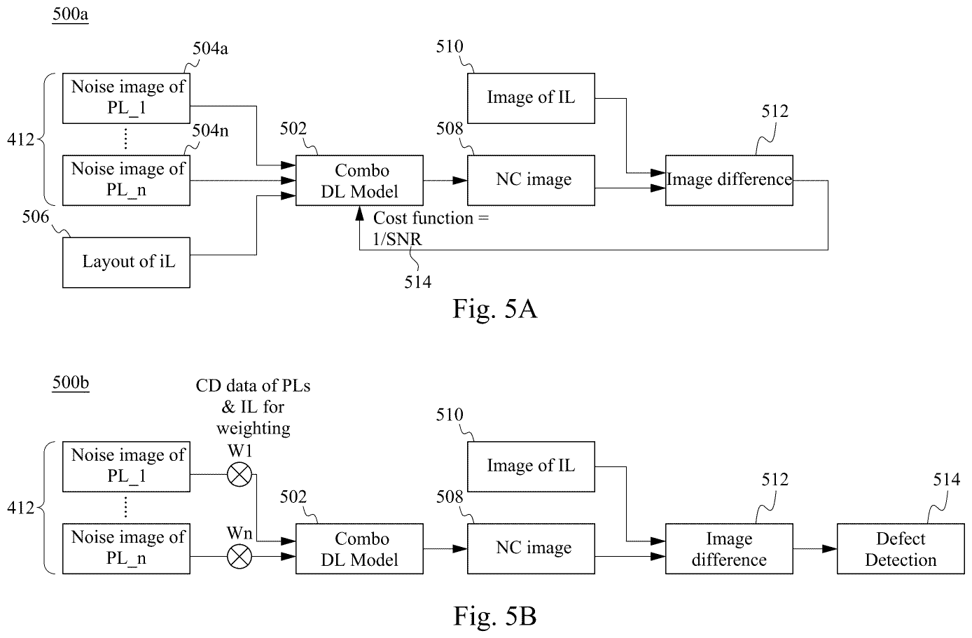

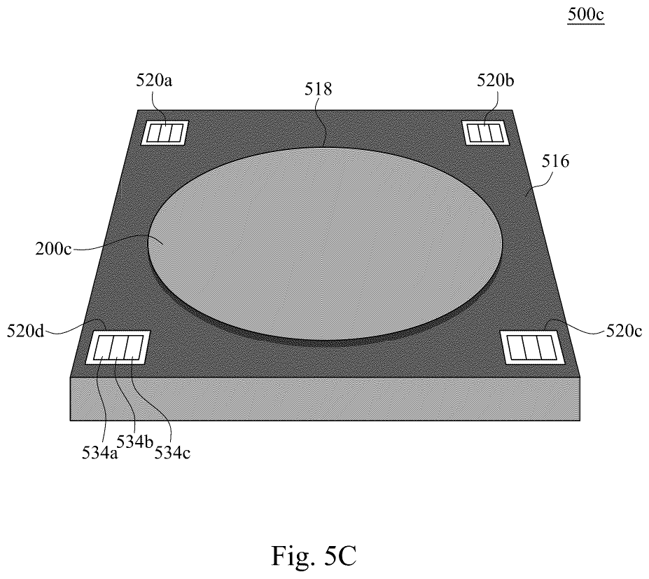

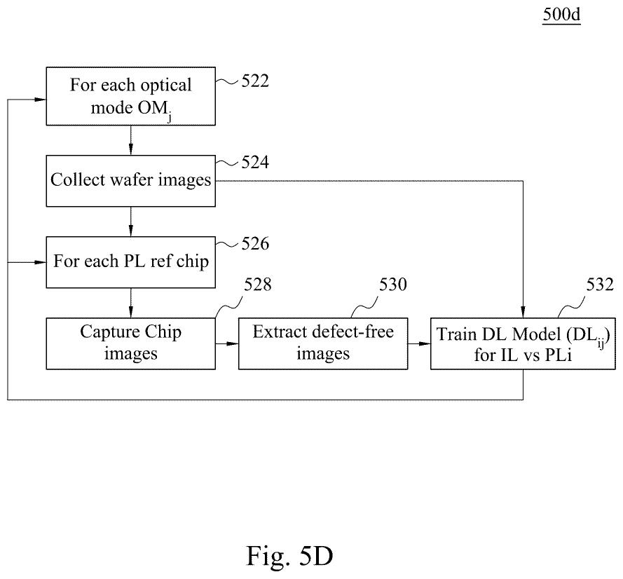

FIG. 5A is a block diagram 500a of details of a method of training a second deep learning model, according to various embodiments. In block 502, input information to the second deep learning model includes the plurality of noise-cancelation images 412, generated by the first deep learning model (i.e., see block 410 of FIG. 4C), as indicated in blocks 504a to 504n, where n is a positive, non-zero integer representing the number of noise-cancelation images 412. In block 506, input information to the second deep learning model further includes a design layout of the inspection layer. In block 508, the output of the second deep learning model is a single noise-cancellation image that is generated as a weighted sum of all of the input noise-cancellation images 412.

In block 510, a second image 104 of an inspection layer 200c having known defects (206a, 206b) (e.g., see FIG. 2C) is used to generate an image difference, as indicated in block 512. The combined noise cancellation image of block 508 is then subtracted from the second image 104 to reduce noise signals (204a′, 204b) of the second image 104 to generate an image difference, as indicated in block 512. A defect detection algorithm is then applied to the corrected second image to determine defect signals (302a, 302b). A cost function 514 is then defined as 1/SNR, where SNR is a signal-to-noise ratio computed by taking a ratio of one or more of the defect signals (302a, 302b) to an average value of residual noise in the corrected second image 104. The second deep learning model of FIG. 5A is then trained by adjusting various weights in the model to minimize the cost function. In this regard, the weights include weights associated with pairs of nodes in the neural network as well as weights associated with the weighted sum of noise-cancellation images indicated in block 502.

FIG. 5B is a block diagram of details of a method of applying the second deep learning model for defect detection, according to various embodiments. The second deep learning model is applicable in practical situations for defect detection in semiconductor wafers and devices, after the second deep learning model has been trained, e.g., as described above with reference to FIG. 5A. In this regard, during a manufacturing process, at each prior layer, first images 102 are collected using a respective optimized optical mode. The first images 102 are then supplied to the first deep learning model 410 to generate a respective plurality of noise cancellation images 412. In FIG. 5B, this plurality of noise cancellation images 412 is then supplied as input to the second deep learning model, as indicated in block 502 of FIG. 5B.

Weights W1 . . . Wn (e.g., see FIG. 5B) associated with a weighted sum of these noise cancellation images 412 are then adjusted, as needed, to account for differences in geometry (e.g., CD differences) between the prior layers (200a, 200b) in the semiconductor device being inspected and corresponding prior layers that were used to train the first and second deep learning models. According to some embodiments, the weights W1 . . . Wn are further adjusted to account for differences in geometry of the inspection layer 200c of the semiconductor device being inspected and the corresponding inspection layers used to train the first and second deep learning models.

In block 508, the output of the second deep learning model is a combined noise-cancellation image that is subtracted from a second image 104 of an inspection layer (e.g., see block 510) to generate an image difference, as indicated in block 512. The image difference of block 512 is a noise-reduced corrected second image 104 usable for defect detection, as indicated in block 514.

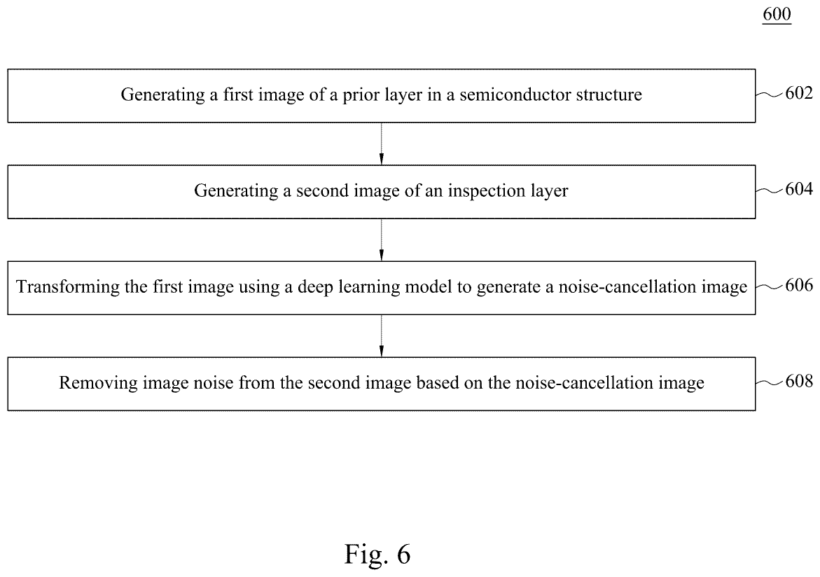

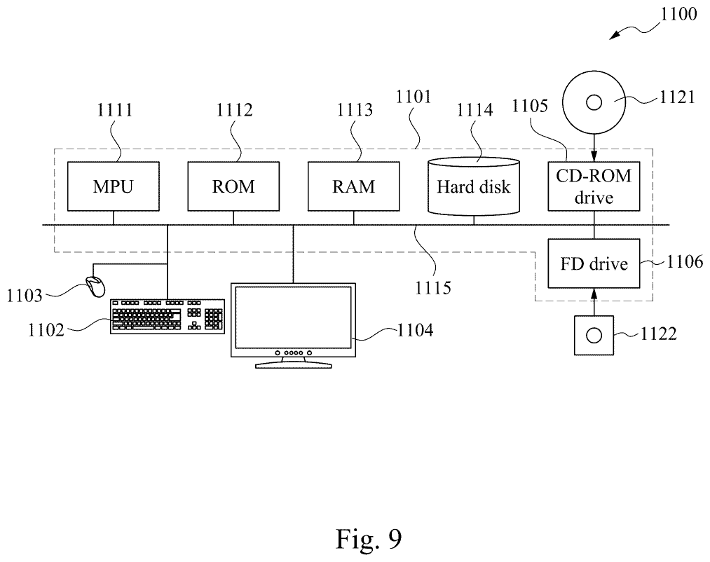

FIG. 9 is a schematic view of a computer system 100 configured to perform the methods of FIGS. 6, 7, 8, according to various embodiments. In some embodiments, the apparatus (also referred to herein as a computer system) 1100 includes an optical simulator and/or defect detection apparatus 1100. All of or a part of the processes, methods, and/or operations of the above-described embodiments are realized using computer hardware and computer programs executed thereon. The computer 1101 is provided with, in addition to the optical disk drive 1105 and the magnetic disk drive 1106, one or more processors 1111, such as a micro processing unit (MPU), a read-only memory (ROM) 1112 in which a program, such as a boot-up program is stored, a random access memory (RAM) 1113 that is connected to the MPU 1111 and in which a command of an application program is temporarily stored and a temporary storage area is provided, a hard disk 1114 in which an application program, a system program, and data are stored, and a bus 1115 that connects the MPU 1111, the ROM 1112, and the like. Note that the computer 1101 may include a network card (not shown) for providing a connection to a LAN. In some embodiments, one or more of ROM 1112, RAM 1113, hard disk 1114 are not included in computer 1101.

Computer program instructions, configured to cause the computer system 1100 to execute the process for defining a mask layout in the foregoing embodiments are stored in a non-transitory computer-readable storage medium, such as an optical disk 1121 or a magnetic disk 1122. Such a storage medium is configured to be inserted into the optical disk drive 1105 or the magnetic disk drive 1106, and transmitted to the hard disk 1114. Alternatively, the program may be transmitted via a network (not shown) to the computer 1101 and stored in the hard disk 1114 (or other non-transitory computer-readable storage medium). At the time of execution, the program is loaded into the RAM 1113. The program may be loaded from the optical disk 1121 or the magnetic disk 1122, or directly from a network. The program does not necessarily need to include, for example, an operating system (OS) or a third-party program to cause the computer 1101 to execute the process for manufacturing the lithographic mask of a semiconductor device in the foregoing embodiments. The program may only include a command portion to call an appropriate function (module) in a controlled mode and obtain desired results.

In some embodiments, recurrent neural networks (RNNs), which are capable of processing sequential data, are applied in scenarios where temporal dependencies exist, such as analyzing time-series data or data from wafer inspection systems that collect measurements over time. In some embodiments, RNNs assist in identifying patterns in data that evolve over time, making such networks suitable for defect tracking or the prediction of future wafer characteristics based on historical data.

Fully connected deep neural networks (DNNs) are more general-purpose networks, where each neuron in one layer is connected to every neuron in the subsequent layer. These models are effective for tasks that do not specifically involve spatial or temporal dependencies, such as predicting certain wafer characteristics from a variety of input features like process parameters or measurements. DNNs are useful in scenarios where complex, non-linear relationships exist between the inputs and outputs.

In some embodiments, these deep learning models are trained using labeled datasets, where the input data is paired with known outcomes, to optimize the parameters of the network. Training is typically performed using a process called backpropagation, which adjusts the weights of the connections between neurons to minimize the error between the predicted output and the true output.

Various embodiments are based on CNNs, that are designed to analyze image data, leveraging the spatial structure inherent in images. These networks are suited for tasks that require hierarchical pattern recognition, such as detecting anomalies or features in images with intricate patterns, like those encountered in semiconductor device fabrication. CNNs operate by learning patterns at multiple levels of abstraction, allowing them to detect both fine-grained features, such as edges and textures, as well as higher-order structures that are important for identifying more complex patterns.

The architecture of a CNN includes several key layers that hierarchically process image data. The convolutional layers apply a set of learnable filters to the input image. Each filter slides across the image, performing a convolution operation that determines local features such as edges, corners, and textures. Multiple filters are applied in parallel to capture different features at various levels. After the convolution operation, the output is typically passed through an activation function, such as Rectified Linear Unit (ReLU), which introduces non-linearity into the network and allows it to model complex patterns. The subsequent pooling layers, usually implementing max pooling, reduce the spatial dimensions of the data while retaining important features, allowing the network to focus on larger, more abstract patterns. Pooling also reduces the computational burden and the number of parameters in the model.

Following these layers, the network typically includes fully connected layers, where the learned features from the convolutional and pooling layers are combined and used to make predictions or classifications. The output layer of the network provides the final result, which can be a classification decision, such as identifying the presence of a defect, or a regression value that indicates the severity or type of anomaly.

One strength of CNNs lies in their ability to learn hierarchical representations of data. In the initial layers, the network captures low-level features, such as simple geometric patterns and textures. As the data progresses through deeper layers, the network begins to combine these low-level features into more complex, abstract patterns, which are crucial for understanding the context of the image. This hierarchical approach enables the network to identify specific features or anomalies, such as deviations from expected patterns or localized defects, which are relevant in the context of the inspection process.

Additionally, CNNs utilize local connectivity and weight sharing, which are integral to their efficiency. In traditional fully connected neural networks, each neuron in one layer is connected to every neuron in the next layer, resulting in a large number of parameters. In contrast, the convolutional layers in CNNs have local connectivity, meaning each neuron is connected only to a small region of the input image. This reduces the number of parameters and allows the network to focus on detecting local features. Furthermore, weight sharing means that the same filter is applied to different parts of the image, enabling the model to capture features that are invariant to their position within the image.

In some embodiments related to semiconductor device fabrication, CNNs are applied to analyze optical images generated during various stages of wafer inspection. The CNN processes the generated images to identify patterns and anomalies that may indicate defects or issues in the semiconductor manufacturing process. By learning to recognize specific patterns in the images, such as deviations from expected geometries or the presence of foreign materials, the CNN is trained to detect a variety of potential defects. The network's ability to learn from labeled data allows the network to generalize learned features to new, unseen images, providing automated and reliable defect detection.

The ability of CNNs to automatically detect and localize defects within complex, high-dimensional image data makes them suited for inspecting semiconductor wafers. Furthermore, CNNs are usable for monitoring the manufacturing process in real time, flagging deviations from the expected patterns or detecting early signs of potential issues. This capability makes CNNs a powerful tool for enhancing the precision and efficiency of semiconductor manufacturing, potentially leading to improved yield and reduced process variability. The hierarchical learning approach inherent in CNNs, combined with their efficiency in handling large-scale image data, enables the identification of subtle, localized anomalies that might otherwise be difficult to detect using traditional methods.

FIG. 4A is a block diagram of details of a method 400a of generating first images 102 of prior layers PLᵢ, according to various embodiments. During a manufacturing process, as each prior layer PLᵢ is formed according to block 401a, a plurality of optical modes OMⱼ are chosen, and as shown in block 401c, a corresponding plurality of first images 102 are generated by scanning each prior layer PLᵢ to generate a first image 102 for each of the plurality of optical modes OMⱼ. The first images 102 of prior layers (PLᵢ, OMⱼ), generated in this way, are then stored for later use in training a first deep learning model, as described in greater detail with reference to FIG. 4B, below.

FIG. 4B is a block diagram 400b of details of a method 400b of training a first deep learning model, and FIG. 4C is a block diagram 404 of further details of the method of training the first deep learning model of FIG. 4B, according to various embodiments. As described above, the first deep learning model includes a neural network defined by a plurality of nodes and a plurality of weights characterizing connections between pairs of nodes within the plurality of nodes. The first deep learning model is trained by adjusting the plurality of weights to generate an optimal image filter “F” that, when applied to each of a plurality of first images 102 of prior layers, generates a respective noise cancelation image that approximates the noise features in a second image 104 of the inspection layer.

In block 402a, first images 102 of prior layers are designated by PLᵢ, wherein the subscript “i” is an integer that designates a particular layer. In block 402b, each first image 102 is further characterized by an optical mode OMⱼ, where the subscript “j” indicates a particular optical mode from a set of optical modes used in capturing the respective first image 102. The optical mode refers to a set of parameters that characterize the light used to capture the first images 102, including but not limited to, wavelength, intensity, polarization, focal length, angle of incidence, or the like. Various types of deep-learning model (e.g., CNN, vision transformer, or the like) are used in respective embodiments, to convert image noise from the various first images 102 to thereby approximate image noise in the second image 104 of the inspection layer.

Thus, according to various embodiments, a deep-learning model identifies noise features in the various prior layers PLᵢ, for each optical mode OMⱼ, and similarly identifies noise features in the second image 104 of the inspection layer. The first deep-learning model is then trained (e.g., see block 404) to function as an image filter that converts the noise features in each of the first images to closely approximate the noise features in the second image 104 of the inspection layer.

With reference to FIG. 4C, the first deep learning model, indicated in block 410, receives two types of information as input. The first information, as shown in block 406, includes a design layout image for each respective prior layer PLᵢ (also referred to as a PL layout mask), and the second, as shown in block 408, includes the first images 102 of prior layers (PLᵢ, OMⱼ) as described above with reference to FIGS. 4A and 4B. As shown in block 412, the first deep-learning model generates separate noise-cancellation images for each respective prior layer PLᵢ, with each noise-cancellation image approximating a portion of noise features of the second image 104 of the inspection layer. In this regard, the deep learning model of block 410 uses optical mode information (e.g., see block 402b of FIG. 4B) to transform noise features of respective prior layer PLᵢ, to approximate corresponding respective noise features in the second image 104 of the inspection layer. A respective image difference is then generated, as indicated in block 420, by subtracting each noise-cancellation image from an image of the inspection layer, as indicated in block 416. The difference image is then used to compute a cost function 414, as follows.

The first deep-learning model is trained by adjusting weights in the neural network to minimize the cost function 414. The cost function 414 is calculated based on differences between respective second images 104 captured using a plurality of optical modes OMⱼ (as indicated in block 416) and respective ones of the noise cancellation images F*PLᵢ (where “F” is a transformation applied to PLᵢ by the first neural network). As indicated in FIG. 4C, there is a matrix of residual noise terms Nᵢⱼ and the first neural network is trained by minimizing the residual noise terms Nᵢⱼ. According to various embodiments, a gradient-descent method is used to adjust the weights in the neural network to minimize the residual noise terms Nᵢⱼ. For example, in certain embodiments, analytical expressions for the residual noise terms Nᵢⱼ as functions of the weights in the neural network are differentiated with respect to the weights to thereby compute gradients of the residual noise terms Nᵢⱼ. The gradients so computed are then used in various gradient-descent algorithms to minimize the residual noise terms Nᵢⱼ thereby optimizing the neural network to generate noise cancellation images F*PLᵢ that closely approximate corresponding noise features in the second images 104 of the inspection layer.

Various functions are used in respective embodiments for computing the residual noise term Nᵢⱼ. For example, in some embodiments, pixel-wise differences are computed between respective ones of the second images 104 (i.e., written as OMⱼ) and the noise-cancellation images F*PLᵢ). Such differences are then squared and summed. A square root of the sum is then computed to form the residual noise terms Nᵢⱼ. Various other functions are usable to generate the residual noise terms Nᵢⱼ in other embodiments. As indicated in block 418, layout information for each prior layer (e.g., a prior layer (PL) mask) is used to align the plurality of noise-cancellation images PLᵢ before performing the subtraction from corresponding second images 104 (i.e., written as OMⱼ).

FIG. 5C is a three-dimensional perspective view of an inspection tool 500c that includes a plurality of custom chips (520a, 520b, 520c, 520d) representing respective prior layers (PL₁, PL₂, PL₃, Pl₄), according to various embodiments. The inspection tool 500c includes a stage 516 configured to hold a wafer 518 that has a top layer that is an inspection layer 200c. The custom chips (520a, 520b, 520c, 520d) are wafer samples each formed and tested/verified to have a structure equivalent to a corresponding prior layer PLᵢ of the wafer 518. As such, first images 102 corresponding to prior layers (PLᵢ, OMⱼ) of the wafer 518 are generated by the inspection tool 500c of FIG. 5C by scanning the custom chips (520a, 520b, 520c, 520d). In this regard, the need to scan the prior layers PLᵢ during the manufacturing process of the wafer 518 is removed, thus simplifying and streamlining the inspection process. In the embodiment inspection tool 500c of FIG. 5C, there are four custom chips (520a, 520b, 520c, 520d) corresponding to four respective prior layers (PL₁, PL₂, PL₃, Pl₄) of the wafer 518. The use of four custom chips (520a, 520b, 520c, 520d) in FIG. 5C is merely provided as an example and greater or fewer custom chips are provided in other embodiments.

FIG. 5D is a block diagram of details of a method 500d of generating first images 102 of prior layers (PLᵢ, OMⱼ) and training (400b, 500a) a deep learning model, according to various embodiments. The method 500d of FIG. 5D is similar to the processes described above with reference to FIGS. 4A to 5B. Unlike the methods of FIGS. 4A to 5B, however, the first images 102 of prior layers (PLᵢ, OMⱼ) are generated by capturing images of the custom chips (520a, 520b, 520c, 520d) rather than by capturing images of prior layers (PLᵢ, OMⱼ) during the manufacturing process of forming the wafer 518. In this regard, as shown in block 522, for each optical mode OMⱼ the method 500d includes capturing one or more images of the wafer 518 as shown in block 524. Similarly, for each optical mode OMⱼ the method 500d includes capturing one or more images of the plurality of custom chips (520a, 520b, 520c, 520d), as indicated in blocks 522, 526 and 528. From the images collected in block 528, defect free images of the custom chips (520a, 520b, 520c, 520d) are extracted as shown in block 530. The image data collected in blocks 522 to 530 is then used to train the deep learning model using methods described above with reference to FIGS. 4B and 5A, as indicated by block 532.

According to various embodiments, the plurality of custom chips (520a, 520b, 520c, 520d) includes various known defects that can be used for mode selection and recipe optimization. As mentioned above, the use of the plurality of custom chips (520a, 520b, 520c, 520d) avoids the need to perform image capturing processes during the manufacturing of the prior layers of the wafer 518. According to various embodiments, the plurality of custom chips (520a, 520b, 520c, 520d) are user-selectable and removable. For example, according to various embodiments, different custom chips correspond to different respective types of wafer 518. As such, the inspection tool 500c is reconfigured as needed for performing inspection processes on different types of wafers. In various embodiments, the inspection tool 500c further includes one or more processor devices (e.g., see FIG. 9) configured to perform the above-described processes for training and applying the deep learning model. As such, the inspection tool 500c is configured for real time model training according to various embodiments.

According to various embodiments, the plurality of custom chips (520a, 520b, 520c, 520d) are chosen from a reference lot whose wafers are used for recipe setup. In this regard, the inspection tool 500c includes calibration chip slots (not shown) that are configured to hold the plurality of custom chips (520a, 520b, 520c, 520d) during scanning. According to various embodiments, each of the plurality of custom chips (520a, 520b, 520c, 520d) is cut from a qualified wafer at a candidate prior-layer and includes three or more dies (534a, 534b, 534c) to facilitate die-to-die (D2D) comparison for distinguishing defect signals from systematic noise in later deep learning model training. The method 500d of FIG. 5D includes scanning the wafer 518 with each candidate OMᵢ (block 522) to collect wafer images (block 524), scanning each of the prior-layer chips (block 526) to generate first images 102 (block 528) corresponding to prior layers (PLᵢ, OMⱼ).

The method 500d further includes decoupling the defect signal from the systematic PL noise by performing D2D comparison of similar images captured from different dies (534a, 534b, 534c) to extract defect-free images, as indicated in block 530. Lastly, as indicated in block 532, the method 500d includes training the deep learning model based on the wafer images (block 524) and the defect-free PL images (block 530). The methods used to train the deep learning model (block 532) are similar to the methods (404b, 404, 500a) described above with reference to FIGS. 4B, 4C, and 5A. For example, in certain embodiments, the cost function 414 (e.g., see FIG. 4C) is the same as described above with reference to FIG. 4C.

According to some embodiments, one or more of the custom chips (520a, 520b, 520c, 520d) is cut from a qualified wafer having a structure corresponding to the inspection layer 200c. Images captured of such chips (corresponding to the inspection layer 200c) serve to provide a benchmark for best-case noise floor in the selection of the best optical mode OMᵢ (block 522). According to some embodiments, the chips corresponding to prior layers (PLᵢ, OMⱼ) are configured to be defect free and in other embodiments, the prior layers (PLᵢ, OMⱼ) are configured to have specific known defects for the purpose of training the deep learning model. For example, in certain embodiments, a defect-free custom chip is good for characterizing systematic noise. On the other hand, in other embodiments, a custom chip with known or programmed defects can be used to benchmark defect signals or to determine a signal-to-noise metric in the selection of a best optical mode.

The described embodiments can be used as an inspection tool for various processes. For example, in certain embodiments, disclosed embodiments can be used as an inspection tool for the purpose of noise reduction and mode selection as applied to electron-beam inspection tools. The placement of the custom chips in the inspection tool have various different configurations (e.g., at isolated locations, or in arrays) in respective embodiments. To support large number of custom chips (e.g., for prior layers of different types of wafers 518) in some embodiments, the custom chips are stored in a bank in the tool, with a mechanism to swap a custom chip between a slot and the bank (not shown). In some embodiments, the custom chips (520a, 520b, 520c, 520d) are also usable for various aspects of tool qualification (e.g., initial tool acceptance, tool matching, tool degradation monitoring, tool calibration, and the like).

FIG. 6 is a flowchart of operations of a method 600 of removing image noise (204a′, 204b) from an image 104 of an inspection layer 200c in a semiconductor device (300), according to various embodiments. In operation 602, the method 600 generates a first image 102 of a prior layer (200a, 200b) in the semiconductor structure 300. The flow proceeds to operation 604. In operation 604, the method 600 generates a second image 104 of an inspection layer 200c. The flow proceeds to operation 606. In operation 606, the method 600 transforms the first image 102 using a deep learning model (410, 502) to generate a noise-cancellation image (412, 508). The flow proceeds to operation 608. In operation 608, the method 600 removes image noise (204a′, 204b) from the second image 104 based on the noise-cancellation image (412, 508).

According to various embodiments, the method 600 further includes aligning the noise-cancellation image (412, 508) and the second image 104 to a design layout (406, 418, 506), and performing a pixel-wise subtraction 512 of the noise-cancellation image (412, 508) from the second image 104 to remove the image noise (204a′, 204b) from the second image 104. According to various embodiments, the deep learning model (410, 502) includes a convolutional neural network or a vision transformer model. According to various embodiments, generating the first image 102 of the prior layer (200a, 200b) in the semiconductor structure 300 further comprises capturing an image of a custom chip (520a, 520b, 520c, 520d) having a structure similar to the prior layer (200a, 200b).

According to various embodiments, the method 600 further includes determining first noise features 204a in the first image 102, determining second noise features (204a′, 204b) in the second image 104, and training the deep learning model (410, 502) to generate the noise-cancellation image (412, 508) from the first image 102 such that the noise-cancellation image (412, 508) approximates the second noise features (204a′, 204b) of the second image 104.

According to various embodiments, the deep learning model (410, 502) determines the first noise features 204a and the second noise features (204a′, 204b) and correlations between the first noise features 204a and the second noise features (204a′, 204b) using a self-attention algorithm. According to various embodiments, the deep learning model (410, 502) includes a neural network defined by a plurality of nodes and a plurality of weights characterizing connections between pairs of nodes within the plurality of nodes, and training the deep learning model (410, 502) further includes adjusting the plurality of weights to minimize a cost function (414, 514) (e.g., see FIGS. 4C and 5A) that minimizes differences between the noise-cancellation image (412, 508) and the second noise features (204a′, 204b) of the second image 104.

According to various embodiments, the method 600 further includes forming pixel-wise differences 512 between the noise-cancellation image (412, 508) and the second image 104, and computing the cost function 414 by forming a sum of squares of the differences (e.g., see FIG. 4C). According to various embodiments, the method 600 further includes determining a relationship between changes in the plurality of weights and corresponding changes in the cost function 414, and minimizing the cost function by performing a gradient descent algorithm to determine values of the plurality of weights that minimize the cost function 414. According to various embodiments, generating the noise-cancellation image (412, 508) further includes training the deep learning model (410, 502) using process and layout information (408, 418, 506) characterizing the first image 102 and the second image 104 such that the deep learning model (410, 502) is configured to determine noise (204a′, 204b) introduced into the second image 104 based on features in the prior layer (200a, 200b).

According to various embodiments, the method 600 further includes training the deep learning model (410, 502) to determine a correlation between a spatial layout (408, 418, 506) of the prior layer (200a, 200b) and corresponding second noise features (204a′, 204b) of the second image 104. According to various embodiments, the method 600 further includes training to the deep learning model (410, 502) to determine a correlation between a material composition (202a, 202b) of the prior layer (200a, 200b) and corresponding second noise features (204a′, 204b) of the second image 104.

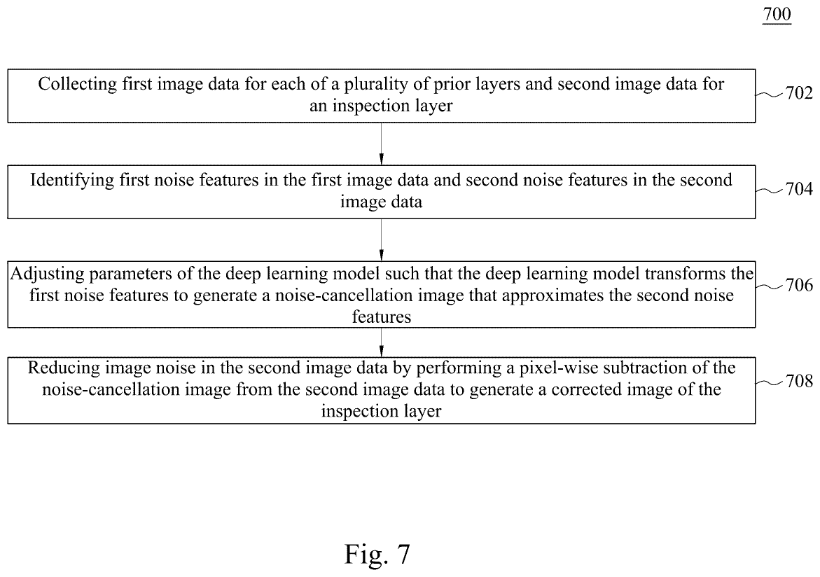

FIG. 7 is a flowchart of operations of a method 700 of removing image noise (204a′, 204b) from an image 104 of an inspection layer 200c in a semiconductor device (300), according to various embodiments. The method 700 includes training a deep learning model (410, 502) in operations 702, 704, and 706, and reducing image noise in operation 708, as follows. In operation 702, the method 700 collects first image 102 data for each of a plurality of prior layers (200a, 200b) and second image 104 data for an inspection layer 200c. The flow proceeds to operation 704. In operation 704, the method 700 identifies first noise features 204a in the first image 102 data and second noise features (204a′, 204b) in the second image 104 data. The flow proceeds to operation 706. In operation 706, the method 700 adjusts parameters of the deep learning model (410, 502) such that the deep learning model (410, 502) transforms the first noise features 204a to generate a noise-cancellation image (412, 508) that approximates the second noise features (204a′, 204b). The flow proceeds to operation 708. In operation 708, the method 700 reduces image noise (204a′, 204b) in the second image 104 data by performing a pixel-wise subtraction 512 of the noise-cancellation image (412, 508) from the second image 104 data to generate a corrected image of the inspection layer 200c.

According to various embodiments, training the deep learning model (410, 502) further includes generating a first weighted sum 412 of the first image 102 data such that weights (W1 . . . Wn) associated with each of the plurality of prior layers (200a, 200b) are determined based on layout and composition (408, 418, 506) information associated with respective ones of the plurality of prior layers (200a, 200b), using the first weighted sum 412 of the first image 102 data as input to the deep learning model (410, 502), and adjusting the weights (W1 . . . Wn) to minimize differences between the noise-cancellation image (412, 508) and the second noise features (204a′, 204b) in the second image 104 data.

According to various embodiments, the method 700 further includes collecting at least two separate images 402a of each of the plurality of prior layers (200a, 200b) by capturing images of custom chips (520a, 520b, 520c, 520d) having structures similar to each of the plurality of prior layers (200a, 200b), capturing the at least two separate images using at least two different optical modes and generating the first weighted sum such that the first image 102 data is weighted according to the at least two different optical modes 402b. According to various embodiments, the method 700 further includes aligning the first image 102 data, the second image 104 data, and the noise-cancellation image (412, 508) to a design layout (406, 418, 506).

According to various embodiments, training the deep learning model (410, 502) further includes training a first deep learning model 410 to generate separate noise-cancellation images 412 for the respective ones of the plurality of prior layers (200a, 200b) using the first image 102 data for each respective prior layer (200a, 200b) and a design layout (406, 418, 506) of each respective prior layer (200a, 200b) as first input data to the first deep learning model 410, and training a second deep learning model 502 to generate a combined noise-cancellation image 508, wherein the second deep learning model 502 uses the separate noise-cancellation images 412 as second input data to the second deep learning model 502. According to various embodiments, during training of the second deep learning model 502, a second weighted sum of the separate noise-cancellation images 412 is adjusted to account for variations in smallest feature dimensions CD or height differences between the plurality of prior layers (200a, 200b) and the inspection layer 200c.

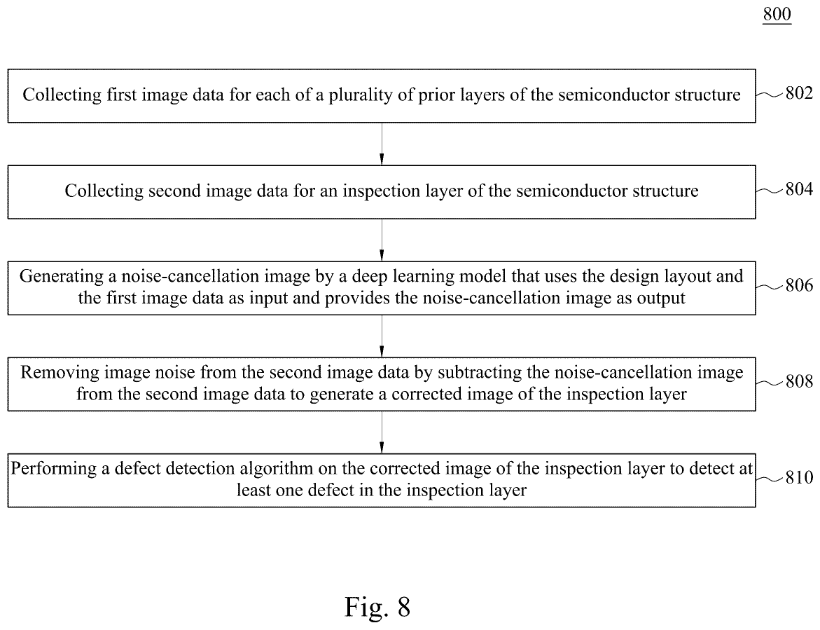

FIG. 8 is a flowchart of operations of a method 800 for defect detection 514 in a semiconductor structure (200a, 200b, 200c), according to various embodiments. In operation 802, the method 800 collects first image 102 data for each of a plurality of prior layers (200a, 200b) of the semiconductor structure (200a, 200b, 200c). The flow proceeds to operation 804. In operation 804, the method 800 collects second image 104 data for an inspection layer 200c of the semiconductor structure (200a, 200b, 200c). The flow proceeds to operation 806. In operation 806, the method 800 generates a noise-cancellation image (412, 508) by a deep learning model (410, 502) that uses the design layout (406, 418, 506) and the first image 102 data as input and provides the noise-cancellation image (412, 508) as output. The flow proceeds to operation 808. In operation 808, the method 800 removes image noise (204a′, 204b) from the second image 104 data by subtracting 512 the noise-cancellation image (412, 508) from the second image 104 data to generate a corrected image of the inspection layer 200c. The flow proceeds to operation 810. In operation 810, the method 800 performs a defect detection algorithm (e.g., C2C or D2D) on the corrected image of the inspection layer 200c to detect at least one defect in the inspection layer 200c.

According to various embodiments, generating the noise-cancellation image (412, 508) further includes generating separate noise-cancellation images 408 for respective ones of the plurality of prior layers (200a, 200b) by applying a first deep learning model 410 that uses the first image 102 data for each respective prior layer (200a, 200b) and a respective design layout (406, 418, 506) of each respective prior layer (200a, 200b) as first input data to the first deep learning model 410, and generating a combined noise-cancellation image 508 by applying a second deep learning model 502 that uses the separate noise-cancellation images 412 as second input data to the second deep learning model 502.

According to various embodiments, generating the combined noise-cancellation image 508 further includes collecting at least two separate images (402a, 412, 412) of each of the plurality of prior layers (200a, 200b) by capturing images of custom chips (520a, 520b, 520c, 520d) having structures similar to each of the plurality of prior layers (200a, 200b), using at least two different optical modes 402b, determining smallest feature dimensions CD for each of the plurality of prior layers (200a, 200b), and generating the combined noise-cancellation image 508 by providing the at least two separate images (402a, 412, 412) and the smallest feature dimensions CD to the deep learning model (410, 502). In such embodiments, the deep learning model (410, 502) is further configured to generate the combined noise-cancellation image 508 based on an optimized weighted sum (e.g., see FIG. 5B) of the separate noise-cancellation images 412 that accounts for variations in the smallest feature dimensions or height variations between the plurality of prior layers (200a, 200b) and the inspection layer 200c and that determines an optimized optical mode 402b for each of the plurality of prior layers (200a, 200b).

Details regarding various neural networks that can be used in other embodiments are provided as follows. Convolutional neural networks (CNNs) are suited for image processing tasks, such as defect detection in semiconductor wafers and devices. These models are designed to automatically extract spatial hierarchies of features from images. In the context of semiconductor fabrication, CNNs can be employed to analyze optical images or difference images and detect patterns or anomalies corresponding to defects or noise. The convolutional layers in these networks allow the model to learn localized features (e.g., edges, textures) from the input images, which are then used for classification or regression tasks, such as defect detection or quality prediction, in some embodiments.

Other embodiments are based on vision transformers, which are a class of deep-learning models specifically designed for analyzing image data. Unlike CNNs that rely on convolutional operations to capture local patterns, vision transformers leverage a transformer-based architecture, which has been successful in natural language processing tasks, and apply the architecture to image analysis. Vision transformers process images as sequences of patches, enabling the model to capture global dependencies and long-range relationships between image regions, which is particularly valuable for complex pattern recognition tasks, such as defect detection in semiconductor device fabrication.

In a vision transformer, an image is first divided into non-overlapping patches. These patches are then flattened into vectors, and positional embeddings are added to each patch to retain the spatial information of their original positions within the image. This sequence of patch embeddings is then fed into a transformer encoder, which processes the patches in parallel, allowing the model to capture interactions between distant regions of the image. The transformer encoder consists of multiple layers, each containing self-attention mechanisms and feedforward networks. The self-attention mechanism enables the model to weigh the importance of different patches relative to each other, allowing the self-attention mechanism to capture complex, global patterns in the image. These self-attention layers allow the model to focus on the most relevant parts of the image, irrespective of their spatial proximity.

The self-attention mechanism works by computing attention scores between all pairs of patches in the image. These attention scores are used to create weighted representations of each patch, allowing the model to learn which regions of the image are important for understanding the overall structure and context. This is in contrast to CNNs, which rely on local receptive fields and may not capture long-range dependencies as effectively. By processing the image as a sequence of patches, the vision transformer can learn global relationships that are useful for tasks such as identifying defects or monitoring complex patterns in semiconductor fabrication.

After the transformer encoder processes the sequence of patch embeddings, the output is typically passed through a classification head or a regression head, depending on the task. The classification head is responsible for producing predictions, such as the presence or absence of defects, while the regression head may be used for tasks requiring continuous outputs, such as predicting defect severity. The output of the transformer model is then used for downstream tasks, such as defect detection, image segmentation, or process optimization in semiconductor manufacturing.

One advantage of vision transformers over traditional CNNs is their ability to capture long-range dependencies and global context from the image data. By treating the image as a sequence of patches, vision transformers can learn complex relationships that may span across large portions of the image, which is useful for applications where the global structure or context of an image is critical for accurate analysis. This capability makes vision transformers suited for tasks such as identifying defects that manifest across large areas of the wafer or detecting subtle anomalies that are not confined to local regions.

Additionally, vision transformers exhibit strong scalability and flexibility. The model's performance improves with the amount of data and computational resources available, making them effective in scenarios where large, high-dimensional image datasets are involved. Vision transformers can also be adapted to different image sizes and resolutions by adjusting the size of the patches and the number of transformer layers.

In some embodiments related to semiconductor device fabrication, vision transformers are applied to analyze optical images from wafer inspection systems, enabling the model to automatically detect and localize defects or process deviations. For example, vision transformers can be trained to recognize specific defect patterns in wafer images, such as surface irregularities, misaligned features, or contamination. The model's ability to capture both local and global patterns in the image allows the model to identify complex defects that span multiple regions of the wafer or exhibit subtle variations in appearance. Once trained, the vision transformer analyzes new wafer images, providing automated and reliable defect detection with high accuracy.

Moreover, vision transformers are used for monitoring the semiconductor fabrication process in real-time, detecting deviations from the expected patterns and flagging potential issues before they lead to significant defects. By capturing both fine-grained and high-level features of the images, vision transformers offer a powerful approach to quality control and process optimization.

In this way, vision transformers provide a novel and effective approach for analyzing image data, particularly in complex tasks like defect detection and process monitoring in semiconductor manufacturing. Their ability to capture long-range dependencies and learn global patterns within an image allows them to excel in applications where traditional CNNs may be less effective. Through their scalability, flexibility, and global pattern recognition capabilities, vision transformers offer a powerful tool for enhancing the accuracy and efficiency of semiconductor device fabrication processes.

Disclosed embodiments are advantageous because they provide methods (600, 700, 800) for inspecting an inspection layer 200c in a semiconductor structure (e.g., semiconductor device structure 300) based on image information 102 collected from one or more previously formed prior layers (200a, 200b). In this regard, disclosed systems 1100 and methods (600, 700, 800) transform images 102 from one or more prior layers (200a, 200b), together with layout (406, 418, 506) and process critical dimensions (CD), to generate one or more noise cancellation images (412, 412, 412) that are most effective in suppressing the noise (204a′, 204b) in the inspection layer image 104. The generation of these nose cancellation images (412, 412, 412) uses deep learning (410, 502) capabilities of vision transformer models which leverage layout information (406, 418, 506) and are conditioned with CD data of the inspected wafer.

According to various embodiments, a method for optical inspection of a semiconductor structure is disclosed. The method includes generating a first image of a prior layer in the semiconductor structure, generating a second image of an inspection layer, transforming the first image using a deep learning model to generate a noise-cancellation image, and removing image noise from the second image based on the noise-cancellation image. According to various embodiments, the method further includes aligning the noise-cancellation image and the second image to a design layout, and performing a pixel-wise subtraction of the noise-cancellation image from the second image to remove the image noise from the second image. According to various embodiments, the deep learning model includes a convolutional neural network or a vision transformer model. According to various embodiments, generating the first image of the prior layer in the semiconductor structure further comprises capturing an image of a custom chip having a structure similar to the prior layer prior layer.

According to various embodiments, the method further includes determining first noise features in the first image, determining second noise features in the second image, and training the deep learning model to generate the noise-cancellation image from the first image such that the noise-cancellation image approximates the second noise features of the second image. According to various embodiments, the deep learning model determines the first noise features and the second noise features and correlations between the first noise features and the second noise features using a self-attention algorithm.

According to various embodiments, the deep learning model includes a neural network defined by a plurality of nodes and a plurality of weights characterizing connections between pairs of nodes within the plurality of nodes, and training the deep learning model further includes adjusting the plurality of weights to minimize a cost function that minimizes differences between the noise-cancellation image and the second noise features of the second image. According to various embodiments, the method further includes forming pixel-wise differences between the noise-cancellation image and the second image, and computing the cost function by forming a sum of squares of the differences. According to various embodiments, the method further includes determining a relationship between changes in the plurality of weights and corresponding changes in the cost function, and minimizing the cost function by performing a gradient descent algorithm to determine values of the plurality of weights that minimize the cost function.

According to various embodiments, generating the noise-cancellation image further includes training the deep learning model using process and layout information characterizing the first image and the second image such that the deep learning model is configured to determine noise introduced into the second image based on features in the prior layer. According to various embodiments, the method further includes training to the deep learning model to determine a correlation between a spatial layout of the prior layer and corresponding second noise features of the second image. According to various embodiments, the method further includes training to the deep learning model to determine a correlation between a material composition of the prior layer and corresponding second noise features of the second image.

According to various embodiments, a method for optical inspection of a semiconductor structure is provided. The method includes training a deep learning model by performing operations including collecting first image data for each of a plurality of prior layers and second image data for an inspection layer, identifying first noise features in the first image data and second noise features in the second image data, and adjusting parameters of the deep learning model such that the deep learning model transforms the first noise features to generate a noise-cancellation image that approximates the second noise features. The method further includes reducing image noise in the second image data by performing a pixel-wise subtraction of the noise-cancellation image from the second image data to generate a corrected image of the inspection layer.

According to various embodiments, training the deep learning model further includes generating a first weighted sum of the first image data such that weights associated with each of the plurality of prior layers are determined based on layout and composition information associated with respective ones of the plurality of prior layers, using the first weighted sum of the first image data as input to the deep learning model, and adjusting the weights to minimize differences between the noise-cancellation image and the second noise features in the second image data. According to various embodiments, the method further includes collecting at least two separate images of each of the plurality of prior layers by capturing images of custom chips having structures similar to each of the plurality of prior layers, capturing the at least two separate images using at least two different optical modes, and generating the first weighted sum such that the first image data is weighted according to the at least two different optical modes. According to various embodiments, the method further includes aligning the first image data, the second image data, and the noise-cancellation image to a design layout.

According to various embodiments, training the deep learning model further includes training a first deep learning model to generate separate noise-cancellation images for the respective ones of the plurality of prior layers using the first image data for each respective prior layer and a design layout of each respective prior layer as first input data to the first deep learning model, and training a second deep learning model to generate a combined noise-cancellation image, wherein the second deep learning model uses the separate noise-cancellation images as second input data to the second deep learning model. According to various embodiments, during training of the second deep learning model, a second weighted sum of the separate noise-cancellation images is adjusted to account for variations in smallest feature dimensions or height differences between the plurality of prior layers and the inspection layer.

According to various embodiments, a method for defect detection in a semiconductor structure is disclosed. The method includes collecting first image data for each of a plurality of prior layers of the semiconductor structure, collecting second image data for an inspection layer of the semiconductor structure, generating a noise-cancellation image by a deep learning model that uses the design layout and the first image data as input and provides the noise-cancellation image as output, removing image noise from the second image data by subtracting the noise-cancellation image from the second image data to generate a corrected image of the inspection layer, and performing a defect detection algorithm on the corrected image of the inspection layer to detect at least one defect in the inspection layer.

According to various embodiments, generating the noise-cancellation image further includes generating separate noise-cancellation images for respective ones of the plurality of prior layers by applying a first deep learning model that uses the first image data for each respective prior layer and a respective design layout of each respective prior layer as first input data to the first deep learning model, and generating a combined noise-cancellation image by applying a second deep learning model that uses the separate noise-cancellation images as second input data to the second deep learning model.

According to various embodiments, generating the combined noise-cancellation image further includes collecting at least two separate images of each of the plurality of prior layers by capturing images of custom chips having structures similar to each of the plurality of prior layers using at least two different optical modes, determining smallest feature dimensions for each of the plurality of prior layers, and generating the combined noise-cancellation image by providing the at least two separate images and the smallest feature dimensions to the deep learning model, which generates the noise-cancellation image. According to various embodiments, the deep learning model is further configured to generate the combined noise-cancellation image based on an optimized weighted sum of the separate noise-cancellation images that accounts for variations in the smallest feature dimensions or height variations between the plurality of prior layers and the inspection layer and that determines an optimized optical mode for each of the plurality of prior layers.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. A method of optical inspection of a semiconductor structure, comprising:
generating a first image of a prior layer in the semiconductor structure;
generating a second image of an inspection layer in the semiconductor structure;
transforming the first image using a deep learning model to generate a noise-cancellation image; and
removing image noise from the second image based on the noise-cancellation image.

2. The method of claim 1, further comprising:
aligning the noise-cancellation image and the second image to a design layout; and
performing a pixel-wise subtraction of the noise-cancellation image from the second image to remove the image noise from the second image.

3. The method of claim 1, wherein the deep learning model comprises a convolutional neural network or a vision transformer model.

4. The method of claim 1, wherein generating the first image of the prior layer in the semiconductor structure further comprises capturing an image of a custom chip having a structure similar to the prior layer.

5. The method of claim 1, further comprising:
determining first noise features in the first image;
determining second noise features in the second image; and
training the deep learning model to generate the noise-cancellation image from the first image such that the noise-cancellation image approximates the second noise features of the second image.

6. The method of claim 5, wherein the deep learning model determines the first noise features and the second noise features and correlations between the first noise features and the second noise features using a self-attention algorithm.

7. The method of claim 5, wherein:
the deep learning model comprises a neural network defined by a plurality of nodes and a plurality of weights characterizing connections between pairs of nodes within the plurality of nodes; and
training the deep learning model further comprises:
adjusting the plurality of weights to minimize a cost function that minimizes differences between the noise-cancellation image and the second noise features of the second image.

8. The method of claim 7, further comprising:
forming pixel-wise differences between the noise-cancellation image and the second image; and
computing the cost function by forming a sum of squares of the differences.

9. The method of claim 8, further comprising:
determining a relationship between changes in the plurality of weights and corresponding changes in the cost function; and
minimizing the cost function by performing a gradient descent algorithm to determine values of the plurality of weights that minimize the cost function.

10. The method of claim 1, wherein generating the noise-cancellation image further comprises:
training the deep learning model using process and layout information characterizing the first image and the second image such that the deep learning model is configured to determine noise introduced into the second image based on features in the prior layer.

11. The method of claim 10, further comprising training the deep learning model to determine a correlation between a spatial layout of the prior layer and corresponding second noise features of the second image.

12. The method of claim 10, further comprising:
training the deep learning model to determine a correlation between a material composition of the prior layer and corresponding second noise features of the second image.

13. A method of optical inspection of a semiconductor structure, comprising:
training a deep learning model by performing operations including:
collecting first image data for each of a plurality of prior layers of the semiconductor structure and second image data for an inspection layer of the semiconductor structure;
identifying first noise features in the first image data and second noise features in the second image data; and
adjusting parameters of the deep learning model such that the deep learning model transforms the first noise features to generate a noise-cancellation image that approximates the second noise features; and
reducing image noise in the second image data by performing a pixel-wise subtraction of the noise-cancellation image from the second image data to generate a corrected image of the inspection layer.

14. The method of claim 13, wherein training the deep learning model further comprises:
generating a first weighted sum of the first image data such that weights associated with each of the plurality of prior layers are determined based on layout and composition information associated with respective ones of the plurality of prior layers;
using the first weighted sum of the first image data as input to the deep learning model; and
adjusting the weights to minimize differences between the noise-cancellation image and the second noise features in the second image data.

15. The method of claim 14, further comprising:
collecting at least two separate images of each of the plurality of prior layers by capturing images of custom chips having structures similar to each of the plurality of prior layers;
capturing the at least two separate images using at least two different optical modes; and
generating the first weighted sum such that the first image data is weighted according to the at least two different optical modes.

16. The method of claim 14, further comprising:
aligning the first image data, the second image data, and the noise-cancellation image to a design layout.

17. The method of claim 14, wherein training the deep learning model further comprises:
training a first deep learning model to generate separate noise-cancellation images for the respective ones of the plurality of prior layers using the first image data for each respective prior layer and a design layout of each respective prior layer as first input data to the first deep learning model; and
training a second deep learning model to generate a combined noise-cancellation image, wherein the second deep learning model uses the separate noise-cancellation images as second input data to the second deep learning model,
wherein, during training of the second deep learning model, a second weighted sum of the separate noise-cancellation images is adjusted to account for variations in smallest feature dimensions or height differences between the plurality of prior layers and the inspection layer.

18. A method of defect detection in a semiconductor structure, comprising:
collecting first image data for each of a plurality of prior layers of the semiconductor structure;
collecting second image data for an inspection layer of the semiconductor structure;
generating a noise-cancellation image by a deep learning model that uses a design layout for the semiconductor structure and the first image data as input and provides the noise-cancellation image as output;
removing image noise from the second image data by subtracting the noise-cancellation image from the second image data to generate a corrected image of the inspection layer; and
performing a defect detection algorithm on the corrected image of the inspection layer to detect at least one defect in the inspection layer.

19. The method of claim 18, wherein generating the noise-cancellation image further comprises:
generating separate noise-cancellation images for respective ones of the plurality of prior layers by applying a first deep learning model that uses the first image data for each respective prior layer and a respective design layout of each respective prior layer as first input data to the first deep learning model; and
generating a combined noise-cancellation image by applying a second deep learning model that uses the separate noise-cancellation images as second input data to the second deep learning model.

20. The method of claim 19, wherein generating the combined noise-cancellation image further comprises:
collecting at least two separate images of each of the plurality of prior layers, by capturing images of custom chips having structures similar to each of the plurality of prior layers, using at least two different optical modes;
determining smallest feature dimensions for each of the plurality of prior layers; and
generating the combined noise-cancellation image by providing the at least two separate images and the smallest feature dimensions to the deep learning model that is further configured to generate the combined noise-cancellation image based on an optimized weighted sum of the separate noise-cancellation images that accounts for variations in the smallest feature dimensions or height variations between the plurality of prior layers and the inspection layer and that determines an optimized optical mode for each of the plurality of prior layers.
